(19) United States
(12) Patent Application Publication
(10) Pub. No.: US 2015/0358746 A1
(43) Pub. Date: Dec. 10, 2015

(54) ACOUSTICAL CROSSTALK COMPENSATION

(71) Applicant: Sonion Nederland B.V., Hoofddorp (NL)

(72) Inventors: Anne-Marie Sänger, Koog a/d Zaan (NL); Andreas Tiefenau, Koog a/d Zaan (NL)

(21) Appl. No.: 14/729,683

(22) Filed: Jun. 3, 2015

(30) Foreign Application Priority Data
Jun. 4, 2014 (EP) 14171061.6

(51) Int. Cl. H04R 25/00; H04R 3/02

(52) U.S. Cl. CPC H04R 25/453; H04R 3/02; H04R 2460/01; H04R 2410/01

(57) ABSTRACT

A method for compensating for acoustic crosstalk between a first and a second microphone unit being acoustically connected to a shared volume. The method includes the steps of providing a first output signal, Pₒᵤₜ, from the first microphone unit, providing a second output signal, Uₒᵤₜ, from the second microphone unit, and generating a compensated output signal by combining a portion of one of the output signals with the other output signal via addition or subtraction in order to compensate for acoustical crosstalk. The invention further relates to a microphone module configured to implement the before-mentioned method. The invention further relates to a hearing aid comprising the microphone module.

### CROSS-REFERENCE TO RELATED APPLICATION

This application claims the benefit of European Patent Application Serial No. 14171061.6, filed Jun. 4, 2014, and titled “Acoustical Crosstalk Compensation,” which is incorporated herein by reference in its entirety.

### FIELD OF THE INVENTION

The present invention relates to compensation of acoustical crosstalk between two microphones units being acoustically connected to a shared volume. In particular, the present invention relates to a method and a microphone module for hearing aid applications, said method and microphone module being arranged to compensate for acoustical crosstalk between two microphone units.

### BACKGROUND OF THE INVENTION

Various combinations of Omni directional microphones and directional microphones have been suggested over the years.

As an example WO 2012/139230 discloses various combinations of Omni directional microphones and directional microphones.

In the embodiments depicted in FIG. 13 of WO 2012/139230 an Omni directional microphone “p” is combined with a directional microphone “u”. The two microphones are both acoustically connected to the combined front volume (11, 12). Moreover, the two microphones share the same sound inlet (3). A rear sound inlet (2) is acoustically connected to the rear volume of the directional microphone.

It is a disadvantage of the embodiment shown in FIG. 13 of WO 2012/139230 that acoustical crosstalk will occur between the front volumes (11) and (12). The acoustical crosstalk between the front volumes will introduce a certain amount of unwanted directionality of the Omni directional microphone.

It may be seen as an object of embodiments of the present invention to provide an arrangement and an associated method where the influence of acoustical crosstalk is controlled.

It may be seen as a further object of embodiments of the present invention to provide an arrangement and an associated method where the influence of acoustical crosstalk is significantly reduced.

### SUMMARY OF INVENTION

The above-mentioned objects are complied with by providing, in a first aspect, a method for compensating for acoustic crosstalk between a first and a second microphone unit being acoustically connected to a shared volume, the method comprising the steps of
proving or providing a first output signal, Pₒᵤₜ, from the first microphone unit,
proving or providing a second output signal, Uₒᵤₜ, from the second microphone unit, and
generating a compensated output signal by combining a portion of one of the output signals with the other output signal via addition or subtraction in order to compensate for acoustical crosstalk.

The first and second microphone units may form part of a microphone module suitable for being incorporated into for example a hearing aid. The hearing aid may further include suitable electronics and speaker units. The hearing aid may belong to one of the standard types of hearing aids, i.e. In the Canal (ITC), Behind the Ear (BTE) or Completely in the Canal (CIC).

The term acoustically connected should be understood broadly. Thus, in the present context acoustically connected may involve that the first and second microphone units share the same volume, such as a shared front or rear volume. Alternatively, the first and second microphone units may be connected to a shared front or rear volume by other suitable means, such as via acoustical channels.

The process step of combining a portion of one of the output signals with the other output signal via addition or subtraction in order to compensate for acoustical crosstalk may be performed electronically, such as in the analogue or in the digital domain. Suitable signal processing means, such as microprocessors, may be provided for this specific task.

It is an advantage of the present invention that acoustical crosstalk between closely arranged microphone units in a compact microphone module may be controlled. In fact the present invention allows that compact microphone modules with simple mechanical designs may generate a high quality output signal in terms of directionality.

In a first embodiment of the first aspect the first and second output signals may be combined by subtracting a portion of the second output signal, Uₒᵤₜ, from the first output signal, Pₒᵤₜ, in order to compensate for acoustical crosstalk. The second output signal, Uₒᵤₜ, may be subtracted from the first output signal, Pₒᵤₜ, in accordance with the following expression:

Pₒᵤₜ−X·Uₒᵤₜ

where X may be a frequency dependent or a constant coefficient within the range 0≦X<1. The term frequency dependent is here to be understood as if X varies as a function of the audio frequency, i.e. X(f).

In a second embodiment of the first aspect the first and second output signals may be combined by adding a portion of the first output signal, Pₒᵤₜ, to the second output signal, Uₒᵤₜ, in order to compensate for acoustical crosstalk. The first output signal, Pₒᵤₜ, may be added to the second output signal, Uₒᵤₜ, in accordance with the following expression:

Uₒᵤₜ+X·Pₒᵤₜ

where X may be a frequency dependent or a constant coefficient within the range 0≦X<1.

The shared volume may comprise a shared front volume, or it may comprise a shared rear volume.

In case of a shared front volume the first microphone unit may comprise an Omni-directional microphone, whereas the second microphone unit may comprise a directional microphone. The Omni-directional microphone and the directional microphone may be acoustically connected to a common sound inlet port via the shared front volume. The first and second microphone units may share the same volume.

In a second aspect the present invention relates to a computer program product for performing the method of the first aspect when said computer program product is run on a computer or a microcontroller.

In a third aspect the present invention relates to a microphone module comprising
a first microphone unit providing a first output signal, Pₒᵤₜ,
a second microphone unit providing a second output signal, Uₒᵤₜ, and
a signal processor being adapted to generate a compensated output signal by combining a portion of one of the output signals with the other output signal via addition or subtraction in order to compensate for acoustical crosstalk.

The microphone module according to the third aspect of the present invention may be configured so that it forms a self-contained device that may be incorporated directly into for example a hearing aid. The hearing aid assembly may belong to one of the standard types of hearing aids, i.e. In the Canal (ITC), Behind the Ear (BTE) or Completely in the Canal (CIC).

The microphone units may in principle be any type of microphone, such as MEMS microphones, moving armature type microphones, moving magnet type microphones, moving coil type microphones etc.

In a first embodiment of the third aspect the first and second output signals may be combined by subtracting a portion of the second output signal, Uₒᵤₜ, from the first output signal, Pₒᵤₜ, in order to compensate for acoustical crosstalk. The second output signal, Uₒᵤₜ, may be subtracted from the first output signal, Pₒᵤₜ, in accordance with the following expression:

Pₒᵤₜ−X·Uₒᵤₜ

where X may be a frequency dependent or a constant coefficient within the range 0≦X<1.

In a second embodiment of the third aspect the first and second output signals may be combined by adding a portion of the first output signal, Pₒᵤₜ, to the second output signal, Uₒᵤₜ, in order to compensate for acoustical crosstalk. The first output signal, Pₒᵤₜ, may be added to the second output signal, Uₒᵤₜ, in accordance with the following expression:

Uₒᵤₜ+X·Pₒᵤₜ

where X may be a frequency dependent or a constant coefficient within the range 0≦X<1.

The shared volume may comprise a shared front volume, or it may comprise a shared rear volume.

In case of a shared front volume the first microphone unit may comprise an Omni-directional microphone, whereas the second microphone unit may comprise a directional microphone. The Omni-directional microphone and the directional microphone may be acoustically connected to a common sound inlet port via the shared front volume.

In a fourth aspect, the present invention relates to a hearing aid assembly comprising a microphone module according to the third aspect. The hearing aid assembly may comprise further components like additional processor means and suitable speaker units. The hearing aid assembly may belong to one of the standard types of hearing aids, i.e. In the Canal (ITC), Behind the Ear (BTE) or Completely in the Canal (CIC).

### BRIEF DESCRIPTION OF THE DRAWINGS

The present invention will now be described in further details with reference to the accompanying figures where

FIG. 1 shows a microphone module including an Omni directional microphone and a directional microphone,

FIG. 2 shows the sensitivity of an Omni directional microphone of a microphone module without crosstalk compensation,

FIG. 3 shows the sensitivity of an Omni directional microphone of a microphone module with crosstalk compensation, and

FIG. 4 shows the sensitivity of an Omni directional microphone a of microphone module with crosstalk overcompensation.

While the invention is susceptible to various modifications and alternative forms, specific embodiments have been shown by way of examples in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF PREFERRED EMBODIMENTS

In its most general aspect the present invention relates to a microphone module including at least two microphone units, such as at least one Omni directional microphone and at least one directional microphone being acoustically coupled to a shared volume, such as a shared front or a shared rear volume.

In the present context acoustically coupled should be understood broadly. This means that the two microphones may share the same front or rear volume or they may be acoustically coupled to a common front or rear volume via appropriate means. In order to compensate for acoustical crosstalk between the Omni directional microphone and the directional microphone a portion of the signal from the directional microphone is subtracted from the signal from the Omni directional microphone. Alternatively, a portion of the signal from the Omni directional microphone is added to the signal from the directional microphone for acoustical crosstalk compensation.

The present invention will now be described with reference to a method and microphone module having a shared front volume. The principle of the present invention is however also applicable to methods and arrangements sharing a rear volume.

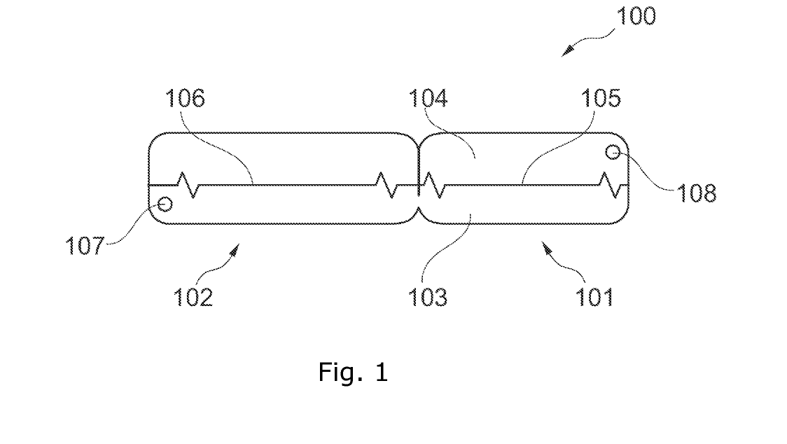

Referring now to FIG. 1 a microphone module 100 having a directional microphone 101 and an Omni directional microphone 102 is depicted. The two microphones share the same front volume 103 which is acoustically connected to the front sound inlet 107. The back volume 104 of the directional microphone 101 is acoustically connected to the delay sound inlet 108. The directional microphone 101 and an Omni directional microphone 102 have respective moveable membranes 105 and 106 arranged within the microphone module 100. Arrangements for converting movements of the membranes 105 and 106 in response to incoming sound waves to electrical signals are, even though not depicted in FIG. 1, provided as well.

The microphone module 100 depicted in FIG. 1 may advantageously be applied in various types of hearing aids in order to convert incoming sound waves to electrical signals. These electrical signals are typically processed, including amplified and filtered, before being applied as a drive signal to a speaker unit.

The difference between the acoustical impedances of the front sound inlet 107 and the delay sound inlet 108 introduces an acoustical delay. This acoustical delay ensures a certain directionality of the microphone module. In a polar plot, and with the directional microphone facing the sound source, the front/rear ratio should preferably take a positive value in that such a positive value enhances speech intelligibility in hearing aids.

If no signal processing is applied to the output signals from the directional microphone and an Omni directional microphone acoustical crosstalk between the two microphones will influence the resulting signal. As a consequence the Omni directional microphone will show a certain directionality which by all means should be avoided.

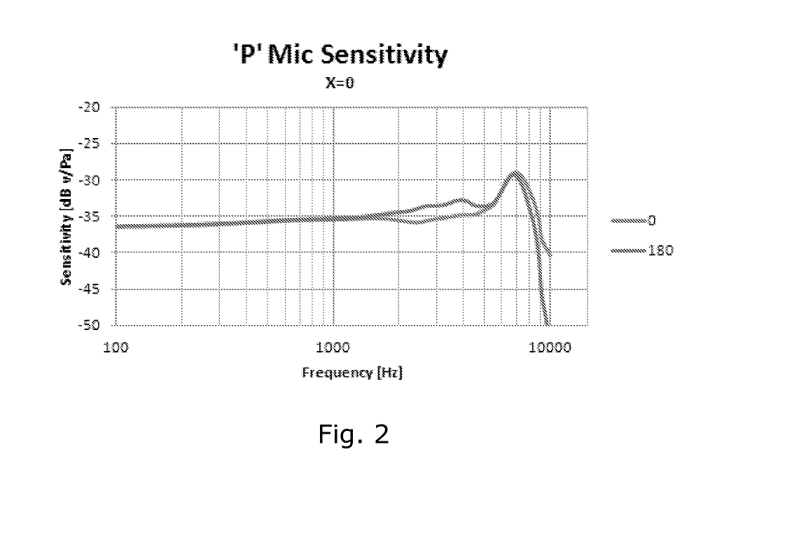

The unwanted directionality of the Omni directional microphone is illustrated by simulations in FIG. 2 where the sensitivity of the Omni directional microphone is depicted for two sound directions, namely zero degrees and 180 degrees. As seen the unwanted directionality of the Omni directional microphone is pronounced between 1.5 kHz and 5.5 kHz.

As addressed previously, the acoustical crosstalk between the directional microphone and the Omni directional microphone may be controlled, such as reduced, by either
1) subtracting a portion of the directional output signal, Uₒᵤₜ, from the Omni directional output signal, Pₒᵤₜ, or
2) adding a portion of the Omni directional output signal, Pₒᵤₜ, to the directional output signal, Uₒᵤₜ

In the following acoustical crosstalk compensation according to the present invention is addressed with reference to point 1) which may be expressed as

Pₒᵤₜ−X·Uₒᵤₜ

where Pₒᵤₜ is the output signal from the Omni directional microphone and Uₒᵤₜ is the output signal from the directional microphone unit. The coefficient X may be a frequency dependent or a constant coefficient within the range 0≦X<1 depending on the selected crosstalk compensation level. By frequency dependent is meant that X varies as a function of the audio frequency, i.e. X(f).

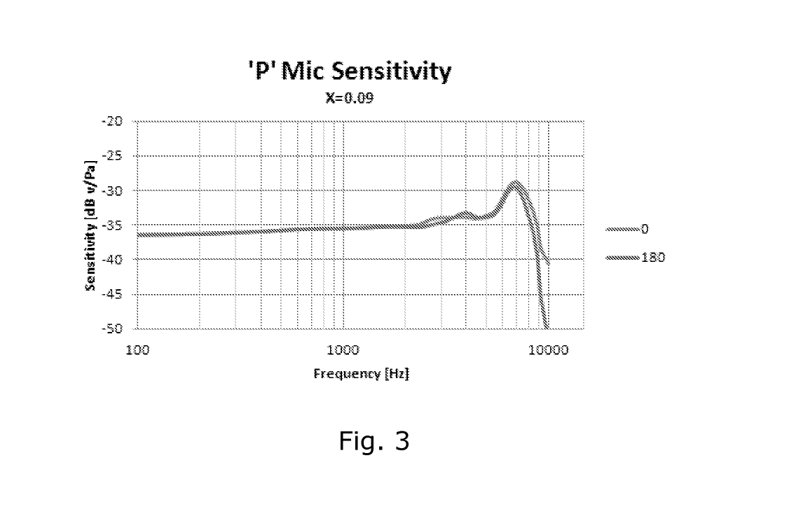

Referring now to FIG. 3 the crosstalk compensation method of the present invention is illustrated. In FIG. 3, Uₒᵤₜ is subtracted from Pₒᵤₜ in a situation where X equals 0.09. As seen in FIG. 3 the Omni directional microphone now shows similar sensitivity curves for sound waves arriving from zero degrees and 180 degrees. Thus, by implementing the method of the present, i.e. by subtracting a part of Uₒᵤₜ from Pₒᵤₜ, the intended Omni directional properties of the Omni directional microphone can be re-established.

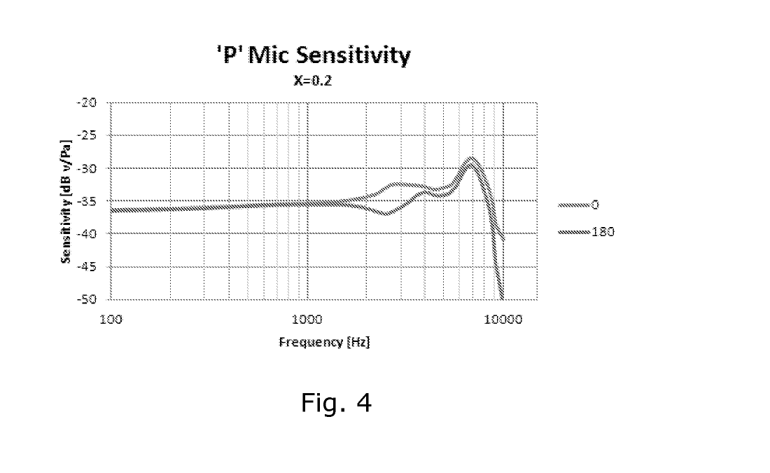

An overcompensated scenario may be reached by increasing X to around 0.2, cf. FIG. 4. In this situation a positive front/rear ratio in the polar plot may be obtained. The resulting directionality of the Omni directional microphone would imitate the natural directionality of the human ear.

1. A method for compensating for acoustic crosstalk between a first and a second microphone unit being acoustically connected to a shared volume, the method comprising the steps of:
providing a first output signal, Pₒᵤₜ, from the first microphone unit,
providing a second output signal, Uₒᵤₜ, from the second microphone unit, and
generating a compensated output signal by combining a portion of one of the output signals with the other output signal via addition or subtraction in order to compensate for acoustical crosstalk.

2. A method according to claim 1, wherein the first and second output signals are combined by subtracting a portion of the second output signal, Uₒᵤₜ, from the first output signal, Pₒᵤₜ, in order to compensate for acoustical crosstalk.

3. A method according to claim 2, wherein the second output signal, Uₒᵤₜ, is subtracted from the first output signal, Pₒᵤₜ, in accordance with Pₒᵤₜ−X·Uₒᵤₜ, where X is a coefficient.

4. A method according to claim 3, wherein the coefficient, X, is frequency dependent.

5. A method according to claim 1, wherein the first and second output signals are combined by adding a portion of the first output signal, Pₒᵤₜ, to the second output signal, Uₒᵤₜ, in order to compensate for acoustical crosstalk.

6. A method according to claim 5, wherein the first output signal, Pₒᵤₜ, is added to the second output signal, Uₒᵤₜ, in accordance with Uₒᵤₜ+X·Pₒᵤₜ, where X is a coefficient.

7. A method according to claim 6, wherein the coefficient, X, is frequency dependent.

8. A method according to claim 1, wherein the shared volume comprises a shared front volume.

9. A method according to claim 1, wherein the shared volume comprises a shared rear volume.

10. A method according to claim 1, wherein the first microphone unit comprises an Omni-directional microphone, and wherein the second microphone unit comprises a directional microphone.

11. A method according to claim 10, wherein the Omni-directional microphone and the directional microphone are acoustically connected to a common sound inlet port via a shared front volume.

12. A method according to claim 1, wherein the first and second microphone units share the same volume.

13. A computer program product for performing the method of claim 1 when said computer program product is run on a computer or a microcontroller.

14. A microphone module comprising
a first microphone unit providing a first output signal, Pₒᵤₜ,
a second microphone unit providing a second output signal, Uₒᵤₜ, and
a signal processor being adapted to generate a compensated output signal by combining a portion of one of the output signals with the other output signal via addition or subtraction in order to compensate for acoustical crosstalk.

15. A microphone module according to claim 14, wherein the first and second output signals are combined by subtracting a portion of the second output signal, Uₒᵤₜ, from the first output signal, Pₒᵤₜ, in order to compensate for acoustical crosstalk.

16. A microphone module according to claim 15, wherein the second output signal, Uₒᵤₜ, is subtracted from the first output signal, Pₒᵤₜ, in accordance with Pₒᵤₜ−X·Uₒᵤₜ, where X is a coefficient.

17. A microphone module according to claim 16, wherein the coefficient, X, is frequency dependent.

18. A microphone module according to claim 14, wherein the first and second output signals are combined by adding a portion of the first output signal, Pₒᵤₜ, to the second output signal, Uₒᵤₜ, in order to compensate for acoustical crosstalk.

19. A microphone module according to claim 18, wherein the first output signal, Pₒᵤₜ, is added to the second output signal, Uₒᵤₜ, in accordance with Uₒᵤₜ+X·Pₒᵤₜ, where X is a coefficient.

20. A microphone module according to claim 19, wherein the coefficient, X, is frequency dependent.

21. A microphone module according to claim 14, wherein the shared volume comprises a shared front volume.

22. A microphone module according to claim 14, wherein the shared volume comprises a shared rear volume.

23. A microphone module according to claim 14, wherein the first microphone unit comprises an Omni-directional microphone, and wherein the second microphone unit comprises a directional microphone.

24. A microphone module according to claim 23, wherein the Omni-directional microphone and the directional microphone are acoustically connected to a common sound inlet port via a shared front volume.

25. A hearing aid assembly comprising a microphone module according to claim 14.
